(19) United States
(12) Patent Application Publication
(10) Pub. No.: US 2017/0340172 A1
(43) Pub. Date: Nov. 30, 2017

(54) INJECTION MOLDING ONE-PIECE CUTTING BOARD

(71) Applicant: Cheng-Che Hsieh, Changhua County (TW)

(72) Inventor: Cheng-Che Hsieh, Changhua County (TW)

(21) Appl. No.: 15/162,830

(22) Filed: May 24, 2016

(51) Int. Cl. A47J 47/00; B29C 45/00

(52) U.S. Cl. CPC A47J 47/005; B29C 45/00

(57) ABSTRACT

An injection molding one-piece cutting board (2) comprises two pre-molding wear-resistant chopping plates (21) spaced apart from each other in parallel. Two holding holes (211) of the two chopping plates (21) are respectively press-fitted at an upper side and a lower side of a positioning block (31) arranged inside an injection molding mold (3). Two open groove portions (32) of the mold (3) are respectively arranged corresponding to an upper side of one chopping plate (21) and a lower side of the other chopping plate (21). A cover groove portion (33) of the mold (3) is surrounded the peripherals of the two chopping plates (21). A plastic material is injected into a space defined between the two chopping plates (21) and then filled with the plastic material to form a middle thickness support (22) and the cover groove portion (33) to form a frame (23).

### FIELD OF THE INVENTION

The present invention relates to a cutting board used in the kitchen, and more particularly to an injection molding one-piece cutting board. Two transparent or non-transparent chopping plates are arranged in a mold and a plastic material is injected into a space defined between the two chopping plates to form a middle thickness support and injected into a cover groove portion arranged inside the mold to from a frame surrounded and covered the peripherals of the two chopping plates.

### BACKGROUND OF THE INVENTION

In general, the cutting board is used for isolating the cuisine or foods while cooking cuisine or cutting foods. The plain and one-piece cutting board is easy to be stained and hard to be recognized. If a top surface of the cutting board is color printed for distinguishing from various foods. The manufacture process of the above mentioned cutting board is described as follows.

Firstly, a long plate is pressed continuously and then a plurality of bottom plates is pre-cut in series. A picture is rubbed or transfer printed on a top surface of each bottom plate.

Secondly, in order to isolate from the pollution and toxicity of the color printing inks, a transparent top plate or thin film may be laminated or covered/coated on the picture. In order to make the cutting board more skidproof, a skidproof layer may be laminated on a bottom surface of the bottom plate.

Due to divisions of several process stages, mass production is not easy to be achieved. The defect rate is too high and it must depend on the quantity of manpower so that the cost is high to result in high price. It is not cheap for the consumers.

After pressing and molding the bottom plates, the bottom surface and the top surface of each bottom plate are printed or coated again. They are not firmly integrated or they may reject each other. Therefore, a protective layer on the surfaces or the skidproof layer may be peeled from the sides of each bottom plate.

If the color printing inks are peeled, especially the printing inks arranged at a middle interposed layer, the printing inks may contact with the foods and the pollution and toxicity of the inks may influence the foods. It is the key drawback of the above mentioned cutting board.

In view of the foregoing circumstances, the inventor has invested a lot of time to study the relevant knowledge, compare the pros and cons, research and develop related products. After quite many experiments and tests, the “injection molding one-piece cutting board” of this invention is eventually launched to improve the foregoing shortcomings, to meet the public use.

### SUMMARY OF THE INVENTION

An objective of this invention is providing an injection molding one-piece cutting board. Two transparent or non-transparent pre-molding wear-resistant chopping plates are arranged in a mold. A plastic material is injected into a space defined between the two chopping plated to form a middle thickness support and injected into a cover groove portion pre-reserved in the mold to surround the peripherals of the two chopping plates and form a frame. The frame may isolate the peripherals of the two chopping plates from outside. The process, assembly, or cutting may be run smoothly without being divided into several stages. The injection molding one-piece cutting board may be manufactured quickly and has the advantages of easy manufacture and low cost.

Another objective of this invention is providing an injection molding one-piece cutting board. An inner side of each chopping plate may be pre-formed a picture so as to be totally isolated, covered, and protected after finishing forming the middle thickness support and the frame. And the user may not contact the picture to achieve the effect of safety.

Another objective of this invention is providing an injection molding one-piece cutting board. A thickness of the frame is thicker than a thickness of the middle thickness support and the two chopping plates so that the chopping plates may be elevated to prevent from contacting with dirty water. The chopping plates may keep clean and safe.

Another objective of this invention is providing an injection molding one-piece cutting board. The structure of the cutting board is firm in one piece so as to prevent from peeling.

To achieve above objectives, an injection molding one-piece cutting board is disclosed. The injection molding one-piece cutting board comprises two pre-molding wear-resistant chopping plates; wherein two holding holes are arranged at one side of each pre-molding wear-resistant chopping plate and corresponding to each other, the two holding holes are respectively bridged and press-fitted at an upper side and a lower side of a positioning block arranged inside an injection molding mold to limit the injection molding mold before closing the mold, the two chopping plates are arranged up and down in the mold and spaces apart from each other, two open groove portions are pre-reserved in a middle section of the mold and respectively corresponding to an upper side of one chopping plate which is arranged at upper position and a lower side of the other chopping plate which is arranged at a lower position, and the two open groove portions are arranged in parallel so as to be pressed and clipped by a top surface and a bottom surface in the mold after closing the mold; a cover groove portion is pre-reserved in the mold and surrounded the peripherals of the two chopping plates; since a diverged plunger is arranged at an inner side of the positioning block, a plastic material is injected into a space defined between the two chopping plates after closing the mold and then the space is filled with the plastic material to form a middle thickness support between the two chopping plates; at the same time, the plastic material is also injected into the cover groove portion to surround the peripherals of the two chopping plates to form a frame which may totally close and cover the peripherals of the two chopping plates; and then a one-piece cutting board is directly molded while opening the mold.

In some embodiments, a thickness of the frame is thicker than a thickness of the middle thickness support and the two chopping plates so that the chopping plates may be elevated to prevent from contacting with dirty water.

In some embodiments, the two chopping plates are non-transparent, and the colors of the two chopping plates may be selected to distinguish the uses or products.

In some embodiments, the two chopping plates are transparent, a color of the middle thickness support may be seen through the two chopping plates, or a picture formed at an inner surface of each chopping plate adjacent to the middle thickness support may be seen so that the picture may be totally isolated by the two chopping plates and the frame.

In some embodiments, a picture may be pre-formed at an inner side of each chopping plate adjacent to the middle thickness support by printing, transfer printing, vacuum laminating, or drawing applying.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is an exploded view of an injection molding one-piece cutting board of the present invention.

FIG. 2 is a partial exploded view of the injection molding one-piece cutting board of the present invention.

FIG. 3 is a perspective view of the injection molding one-piece cutting board of the present invention before closing the mold.

FIG. 4 is a cross-sectional view of FIG. 3 along with line A-A.

FIG. 5 is an exploded view of FIG. 4.

FIG. 6 is a cross-sectional view of FIG. 3 along with line B-B.

FIG. 7 is an exploded view of FIG. 6.

FIG. 8 is a perspective view of the injection molding one-piece cutting board of the present invention after processing injection molding.

FIG. 9 is a perspective view of the injection molding one-piece cutting board of the present invention viewed from another angle after processing injection molding.

### DESCRIPTION OF THE PREFERRED EMBODIMENT

Referring now to the drawings where like characteristics and features among the various figures are denoted by like reference characters.

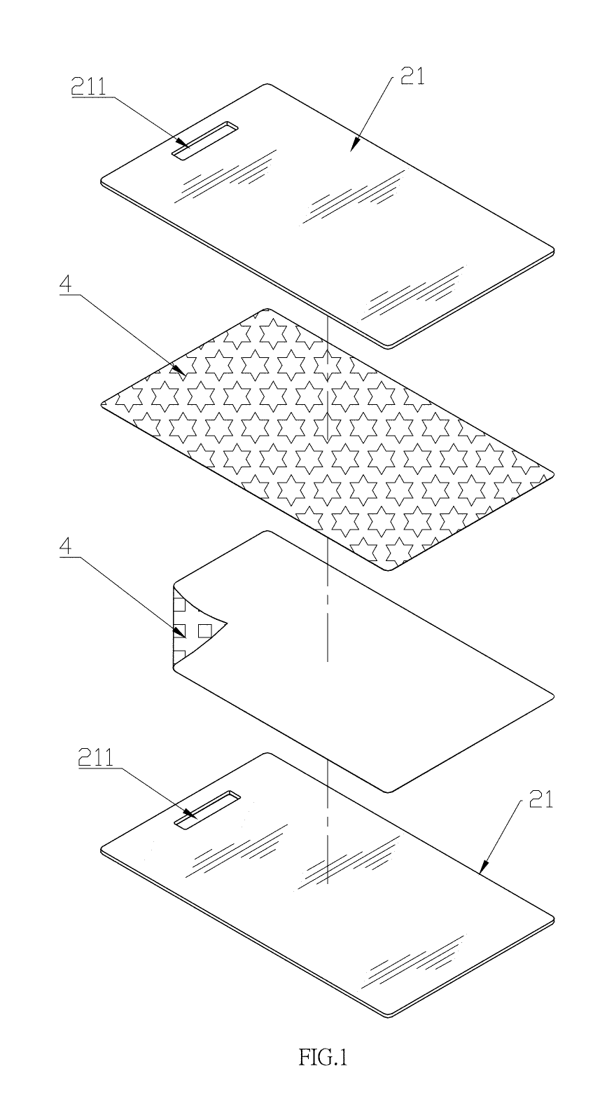

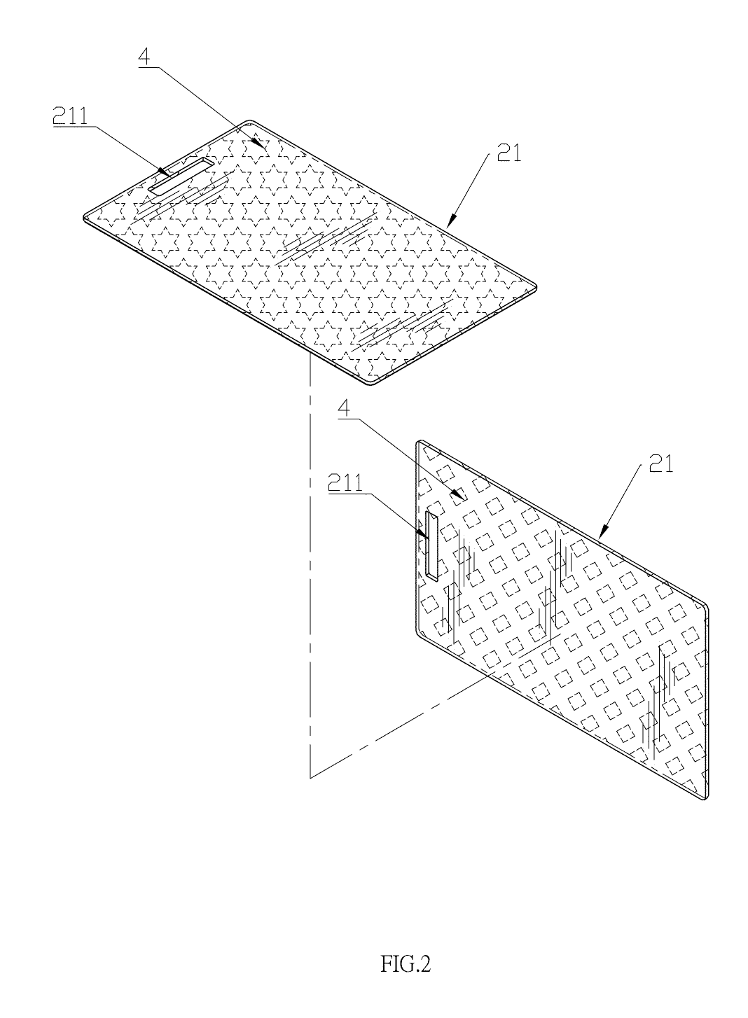

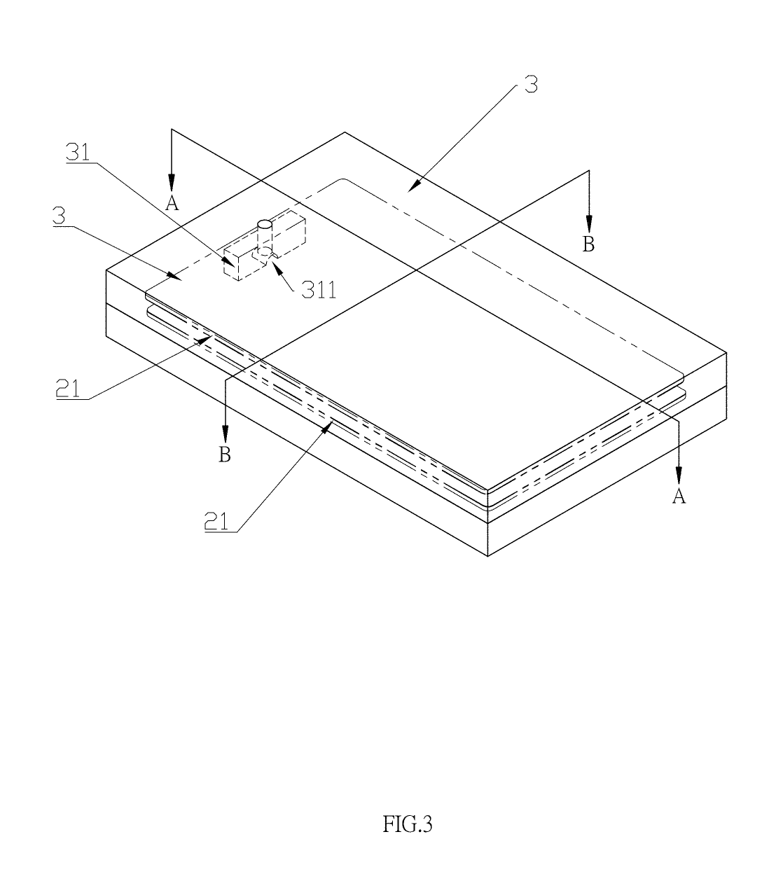

Please refer to FIGS. 1 to 3, an injection molding one-piece cutting board 2 may comprise two pre-molding wear-resistant chopping plates 21. One holding holes 211 is arranged at one side of each pre-molding wear-resistant chopping plate 21 and corresponding to each other. The two holding holes 211 are respectively bridged and press-fitted at an upper side and a lower side of a positioning block 31 arranged inside an injection molding mold 3 to limit the injection molding mold 3 before closing the mold 3. The two chopping plates 21 are arranged up and down in the mold 3 and spaced apart from each other in parallel. Two open groove portions 32 are pre-reserved in a middle section of the mold 3 and respectively corresponding to an upper side of one chopping plate 21 which is arranged at upper position and a lower side of the other chopping plate 21 which is arranged at a lower position. And the two open groove portions 32 are arranged in parallel so as to be pressed and clipped by a top surface and a bottom surface in the mold 3 after closing the mold 3. A cover groove portion 33 is pre-reserved in the mold 3 and surrounded the peripherals of the two chopping plates 21.

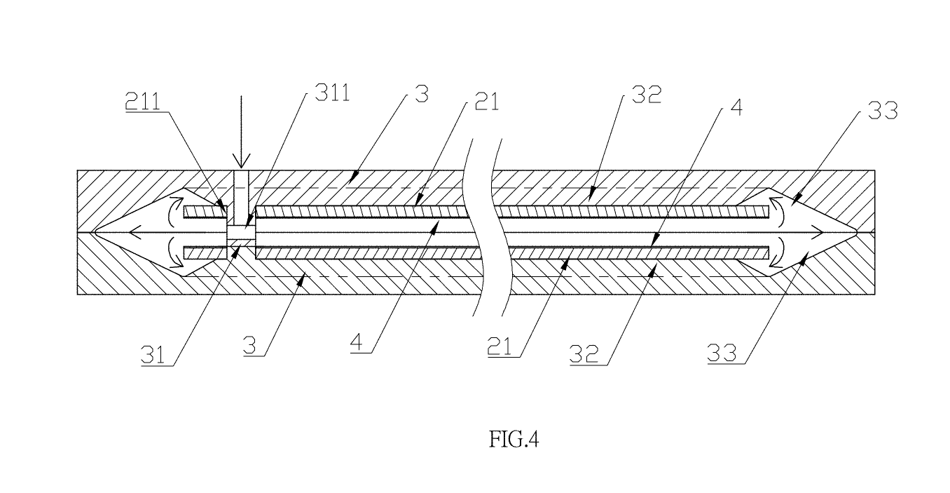

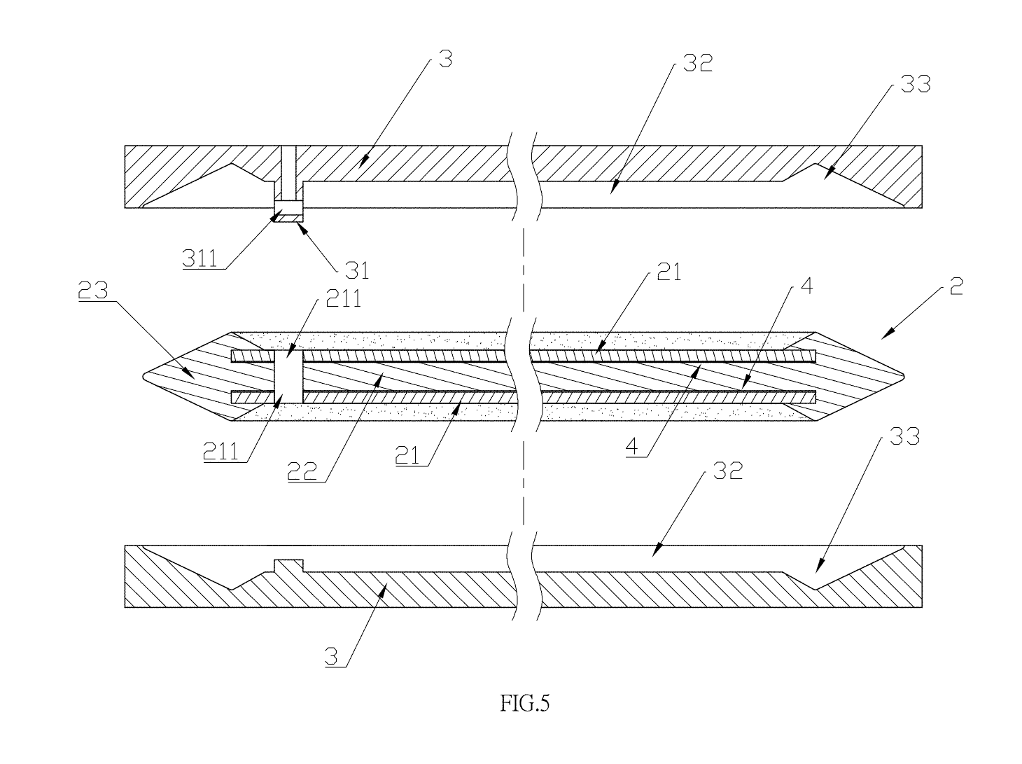

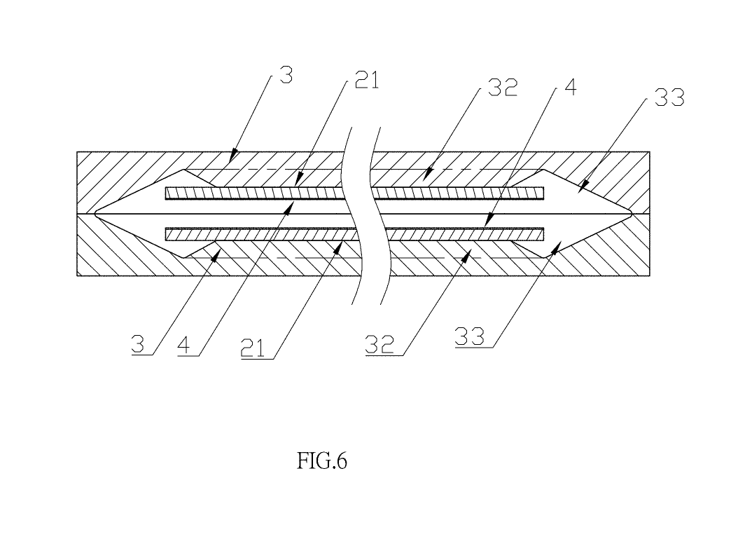

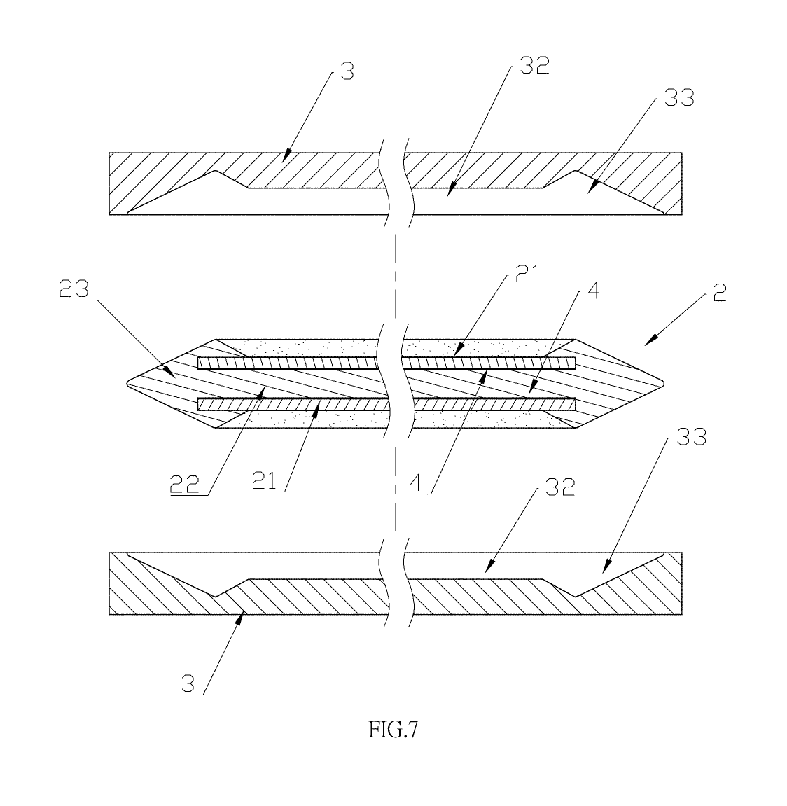

Please refer to FIGS. 4 and 6, since a diverged plunger 311 is arranged at an inner side of the positioning block 31, a plastic material may be injected into a space defined between the two chopping plates 21 after closing the mold 3 and then the space is filled with the plastic material to form a middle thickness support 22 between the two chopping plates 21. At the same time, the plastic material may be also injected into the cover groove portion 33 to surround the peripherals of the two chopping plates 21 to form a frame 23 which may totally close and cover the peripherals of the two chopping plates 21. And then a one-piece cutting board 2 is directly molded while opening the mold 3 (shown as in FIGS. 5 and 7). The additional cutting process is not necessary and the total process is easier. The structure may become much firmer.

Preferably, a thickness of the frame 23 is thicker than a thickness of the middle thickness support 22 and the two chopping plates 21 so that the chopping plates 21 may be elevated to prevent from contacting with dirty water (shown as in FIGS. 5 and 7).

In some embodiments, the two chopping plates 21 may be non-transparent and plain. The colors of the two chopping plates 21 may be selected to distinguish the uses or products.

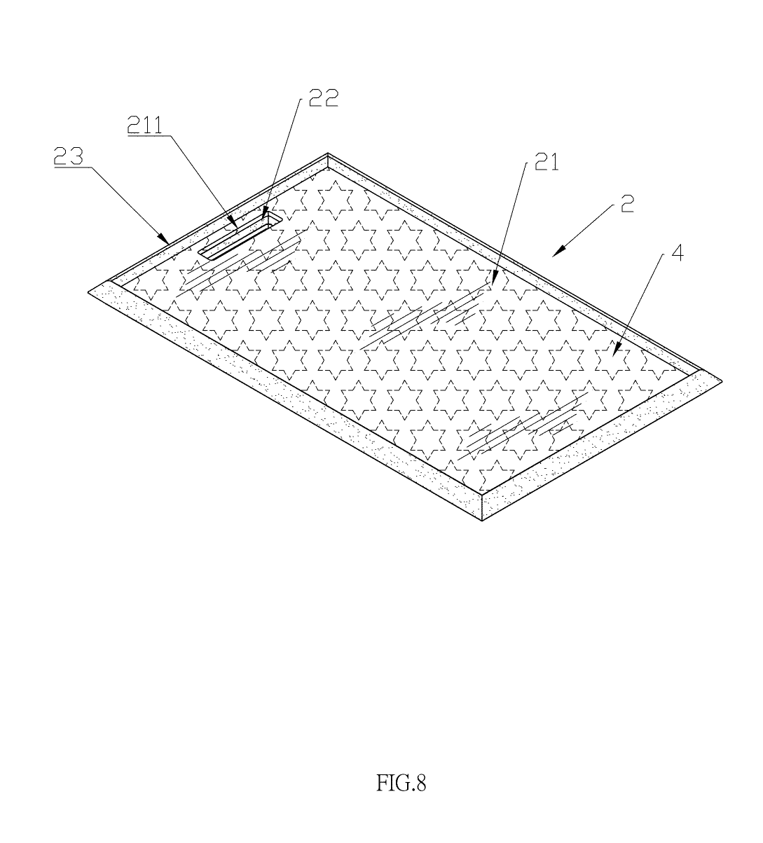

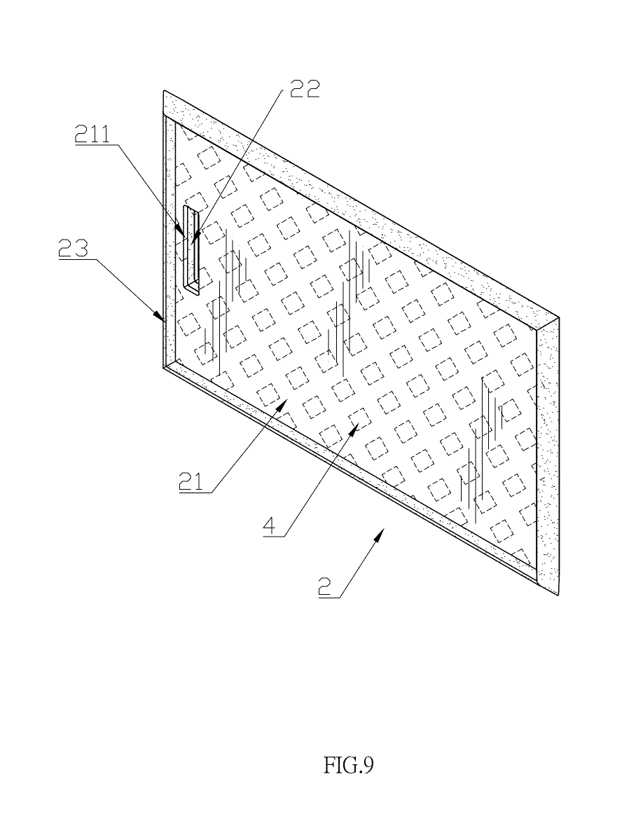

In some embodiments, the two chopping plates 21 may be transparent so that a color of the middle thickness support 22 may be seen through the two chopping plates 21 (shown as in FIGS. 8 and 9). Or, a picture 4 formed at an inner surface of each chopping plate 21 adjacent to the middle thickness support 22 may be seen so that the picture 4 may be totally isolated by the two chopping plates 21 and the frame 23. Therefore, the picture 4 may be protected safely and isolated absolutely to prevent the user from touching the picture 4 (shown as in FIGS. 5 and 7).

Preferably, the picture 4 may be pre-formed at an inner side of each chopping plate 21 adjacent to the middle thickness support 22 by printing, transfer printing, vacuum laminating, or drawing applying.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. An injection molding one-piece cutting board (2), comprising two pre-molding wear-resistant chopping plates (21); wherein one holding hole (211) is arranged at one side of each pre-molding wear-resistant chopping plate (21) and corresponding to each other, the two holding holes (211) are respectively bridged and press-fitted at an upper side and a lower side of a positioning block (31) arranged inside an injection molding mold (3) to limit the injection molding mold (3) before closing the mold (3), the two chopping plates (21) are arranged up and down in the mold (3) and spaced apart from each other in parallel, two open groove portions (32) are pre-reserved in a middle section of the mold (3) and respectively corresponding to an upper side of one chopping plate (21) which is arranged at upper position and a lower side of the other chopping plate (21) which is arranged at a lower position, and the two open groove portions (32) are arranged in parallel so as to be pressed and clipped by a top surface and a bottom surface in the mold (3) after closing the mold (3); a cover groove portion (33) is pre-reserved in the mold (3) and surrounded the peripherals of the two chopping plates (21); since a diverged plunger (311) is arranged at an inner side of the positioning block (31), a plastic material is injected into a space defined between the two chopping plates (21) after closing the mold (3) and then the space is filled with the plastic material to form a middle thickness support (22) between the two chopping plates (21); at the same time, the plastic material is also injected into the cover groove portion (33) to surround the peripherals of the two chopping plates (21) to form a frame (23) which may totally close and cover the peripherals of the two chopping plates (21); and then a one-piece cutting board (2) is directly molded while opening the mold (3).

2. The injection molding one-piece cutting board as claimed in claim 1, wherein a thickness of the frame (23) is thicker than a thickness of the middle thickness support (22) and the two chopping plates (21) so that the chopping plates (21) may be elevated to prevent from contacting with dirty water.

3. The injection molding one-piece cutting board as claimed in claim 1, wherein the two chopping plates (21) are non-transparent, and the colors of the two chopping plates (21) may be selected to distinguish the uses or products.

4. The injection molding one-piece cutting board as claimed in claim 1, wherein the two chopping plates (21) are transparent, a color of the middle thickness support (22) may be seen through the two chopping plates (21), or a picture (4) formed at an inner surface of each chopping plate (21) adjacent to the middle thickness support (22) may be seen so that the picture (4) may be totally isolated by the two chopping plates (21) and the frame (23).

5. The injection molding one-piece cutting board as claimed in claim 1, wherein a picture (4) may be pre-formed at an inner side of each chopping plate (21) adjacent to the middle thickness support (22) by printing, transfer printing, vacuum laminating, or drawing applying.
